(19) United States
(12) Patent Application Publication
(10) Pub. No.: US 2010/0177342 A1
(43) Pub. Date: Jul. 15, 2010

(54) IMAGE FORMING APPARATUS AND CONTROL METHOD THEREOF

(75) Inventor: Hiroki Takeishi, Machida-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/648,085

(22) Filed: Dec. 28, 2009

(30) Foreign Application Priority Data
Jan. 14, 2009 (JP) 2009-006113

(51) Int. Cl. G06F 15/00

(52) U.S. Cl. 358/1.15

(57) ABSTRACT

According to the present invention, first a processing burden for image forming is estimated. Furthermore, based on this estimate, programs executed by a plurality of processing units are reloaded. Then, a plurality of processing apparatuses respectively receive data necessary for processing for image forming, and start rendering processing or image processing.

### BACKGROUND OF THE INVENTION

1. Field of the Invention

The present invention relates to an image forming apparatus and a method for controlling that image forming apparatus, and more specifically relates to image processing and rendering for image forming.

2. Description of the Related Art

There are conventional image forming apparatuses in which, in order to perform rendering and image processing (collectively referred to as image processing) in a short time period, dedicated hardware such as a CPU or an ASIC (referred to as a rendering processing unit) is prepared, and PDL data received from a host computer is processed by the rendering processing unit (see FIG. 2).

Image forming apparatuses have also been proposed in which a plurality of rendering processing units are prepared, and image processing is performed in parallel. When performing that processing, an estimated value of the processing burden for respective scan lines is obtained, and image processing is allocated to the plurality of rendering processing units based on that estimated value (for example, see Japanese Patent Laid-Open No. 10-307924). Thus, the processing burden by the respective rendering processing units is made uniform.

There have also been proposals in which, in order to efficiently distribute the processing in this case, information is prepared whereby it is possible to estimate the processing burden for each type of processing, and the method for allocating processing to a plurality of processing apparatuses is determined based on this information. With this processing, it is possible to make the processing time of the plurality of processing apparatuses generally equal (for example, see Japanese Patent Laid-Open No. 2007-81795).

Even if processing is distributed based on processed data, it is possible that variation in processing time will occur due to differences in performance between rendering processing units. In order to address such an issue, there are schemes in which the processing method of the processing apparatuses is switched (for example, see Japanese Patent Laid-Open No. 11-165434). More specifically, a processing apparatus capable of loading commands to switch executable processing is used as a rendering processing unit, and by switching the commands that are loaded, a processing apparatus appropriate for the data is realized. The commands that are loaded are determined according to the properties of the data.

As described above, by using a processing apparatus capable of switching the commands possible in processing, accelerated processing for image forming is realized. However, there is the problem that a delay time occurs during which the processing apparatus switches the commands possible in processing. Because the data is divided, it is possible that this processing apparatus switching will occur a plurality of times, depending on the data, so that the delay time is further increased, and therefore there is a risk that ultimately the effect of increased speed due to parallelization will be impaired, leading to decreased processing speed.

### SUMMARY OF THE INVENTION

The present invention was made in consideration of the conventional examples described above, and provides an image forming apparatus that realizes increased speed by reducing the number of times that commands possible in processing are switched in a processing apparatus, and a method for controlling that image forming apparatus.

In an aspect of the present invention, the following configuration is provided.

In an aspect of the present invention, there is provided an image forming apparatus having a plurality of processors and a controller that controls the processors, the image forming apparatus including: a unit configured to obtain, for target data that has been converted to blocks and is the target of image forming processing, a weighting coefficient of the processing burden of each attribute included in the target data, based on an indicator value that indicates a number of blocks of each attribute and a processing burden for each attribute; a unit configured to use a ratio of the weighting coefficients to determine a number of processors that process blocks of each attribute from among the plurality of processors, and allocate a processor to each attribute; a unit configured to load a processing program corresponding to the attribute allocated to each processor in a local memory of the respective processors; a unit configured to perform control such that for each block of the target data, the processing program is executed and processing is performed by the allocated processor corresponding to the attribute of the corresponding block; and a unit configured to combine the processed data of blocks processed by the processor.

According to this aspect of the invention, there is the effect of increasing the speed of processing when performing distributed processing using a plurality of processors.

Further features of the present invention will become apparent from the following description of exemplary embodiments with reference to the attached drawings.

### BRIEF DESCRIPTION OF THE DRAWINGS

FIG. 1 shows the configuration of an image forming apparatus and information processing apparatus according to an embodiment of the present invention.

FIG. 2 shows the configuration of a conventional image forming apparatus and information processing apparatus.

FIG. 3 shows the flow of processing in an embodiment of the present invention.

FIG. 4 shows PDL data.

FIG. 5 shows print data.

FIG. 6 shows the configuration of an image forming processing apparatus in an embodiment of the present invention.

FIG. 7 shows image forming processing in an embodiment of the present invention.

FIG. 8 shows intermediate data.

FIG. 9 shows an example of intermediate data in an embodiment of the present invention.

FIG. 10 shows an example of intermediate data and attribute information in an embodiment of the present invention.

FIG. 11 shows processing for image forming in an image processing apparatus.

FIG. 12 shows commands of a processing apparatus.

FIG. 13 shows processing to load commands to a processing apparatus.

FIGS. 14A and 14B show processing to select a command group in an embodiment of the present invention.

FIGS. 15A and 15B show processing to generate print data in an embodiment of the present invention.

FIG. 16 shows a table of weighting parameters in an embodiment of the present invention.

### DESCRIPTION OF THE EMBODIMENTS

Following is a description of an embodiment of the invention with reference to the attached drawings.

### Image Forming Processing

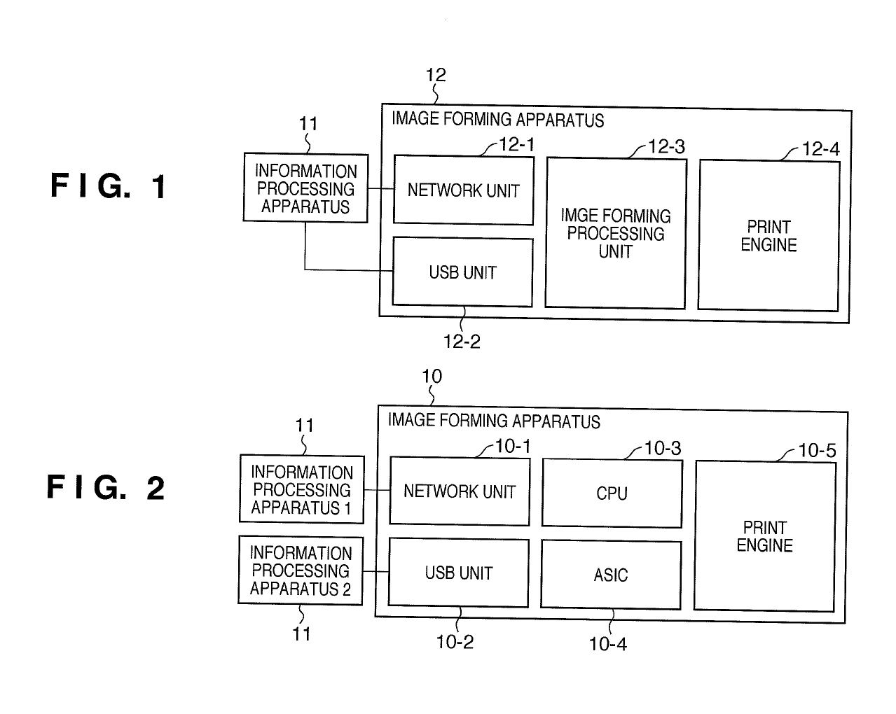

FIG. 1 is a block diagram that shows the configuration of an image forming apparatus 12 and an information processing apparatus 11 connected to the image forming apparatus according to one embodiment of the present invention. In FIG. 1, the information processing apparatus 11 is an information processing apparatus such as a personal computer. The information processing apparatus 11 is capable of generating PDL (Page Description Language) data 100 in the same apparatus. Furthermore, the information processing apparatus 11 is capable of transferring data that includes the PDL data 100 to an apparatus external to the information processing apparatus 11, for example, the image forming apparatus 12, via an interface typified by a network or USB.

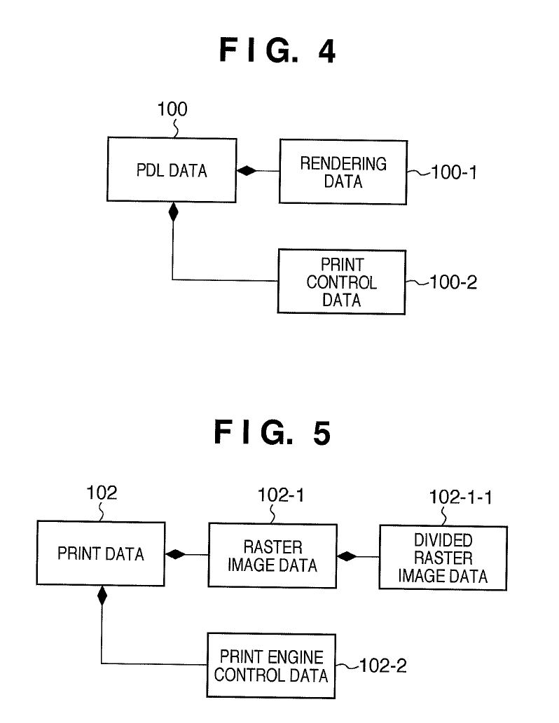

The PDL data 100, as shown in FIG. 4, can include rendering data and print control data. Rendering data is data that the image forming apparatus 12 can interpret and visibly render. The print control data is information that includes what method should be used when performing image forming of the PDL data 100. For example, the print control data can indicate information that designates a paper size and a paper type. Also, information in the print control data 100-2 can indicate information for processing performed after image forming, including a binding processing method or the like.

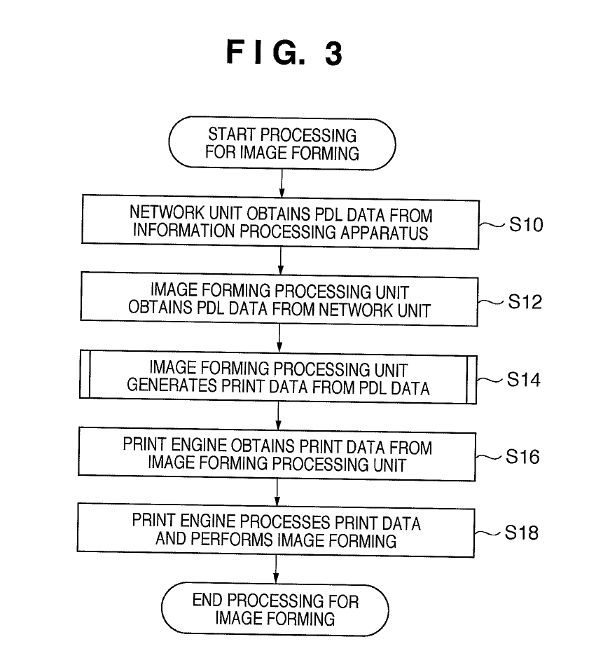

Next is a description of the image forming apparatus 12. The image forming apparatus 12 is a printer or multifunction peripheral or the like, and is capable forming a visible image on a sheet medium typified by paper, based on data typified by the PDL data 100. Following is a description of processing for image forming, in order for the image forming apparatus 12 to form a visible image on a sheet medium. FIG. 3 is a flow diagram of processing for image forming performed by the image forming apparatus 12.

In FIG. 3, first, in S10 a network unit 12-1 receives PDL data from the information processing apparatus 11. The network unit 12-1 is capable of obtaining data that includes PDL data by performing communications with another apparatus by a protocol typified by IEEE 802.3. In the processing of S10, data including PDL data may also be obtained by performing communications with another apparatus using a USB unit 12-2. Additionally, the present invention can also be implemented by obtaining data that includes PDL data by connecting the image forming apparatus 12 to another apparatus via an interface compliant with IEEE 1394a, RS-232C, or IEEE 1284.

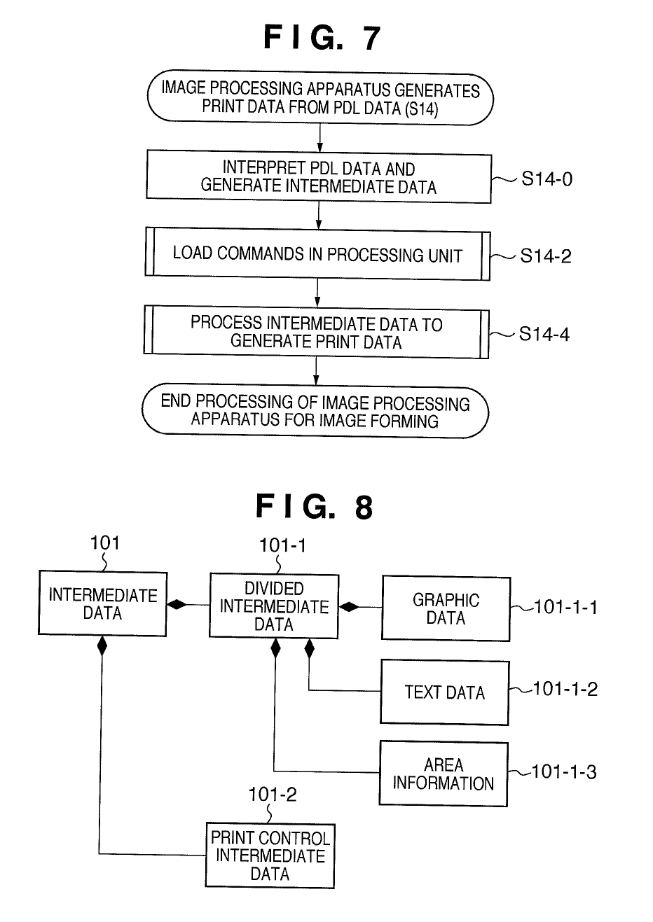

The PDL data obtained by the image forming apparatus 12 from another apparatus, typified by the information processing apparatus 11, is then transferred to an image forming processing unit 12-3 within the image forming apparatus 12 (S12). Next, in S14, the image forming processing unit 12-3 generates print data based on the PDL data obtained in S12. The details of S14 will be described later with reference to FIG. 7. Next, in S16, a print engine 12-4 obtains this print data 102. As shown in FIG. 5, the print data 102 includes raster image data 102-1 and print engine control data 102-2. The print engine performs image forming based on the obtained print data 102 to form a visible image on a print medium, typified by paper or the like (S18). The raster image data 102-1 is converted into blocks by division into a plurality of blocks (or tiles) 102-1-1, and after processing is performed on each block, recombined to reproduce the raster image data 102-1. The data used for image forming by the print engine 12-4 is this reproduced raster image data 102-1.

### Processing by Image Forming Processing Unit

Up to this point, the image forming performed by the image forming apparatus 12 has been described. Next is a more detailed description of the processing indicated by S14 in FIG. 3 in that image forming, performed within the image forming processing unit 12-3.

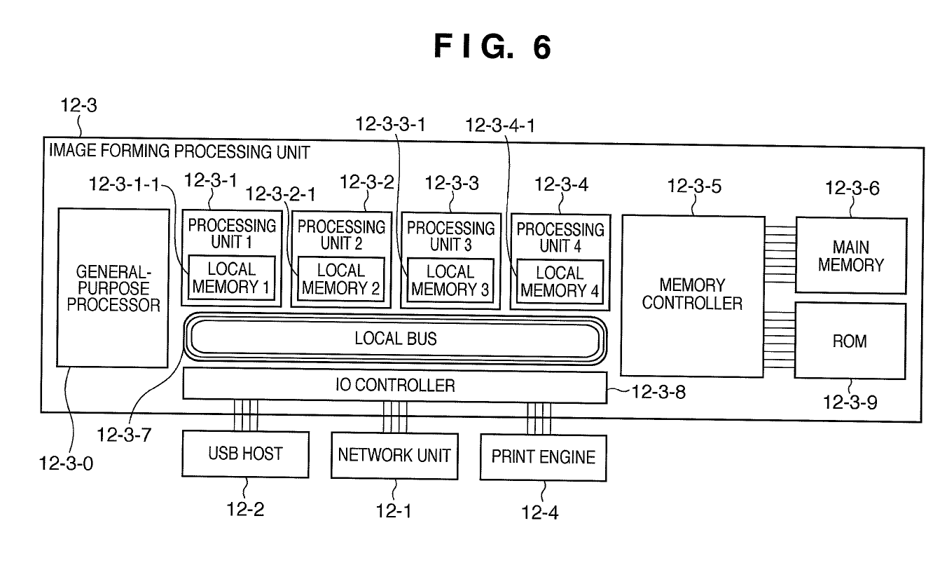

FIG. 6 shows the configuration of the image forming processing unit 12-3 in the image forming apparatus 12. The image forming processing unit 12-3 has a general-purpose processor 12-3-0 typified by a CPU. This general-purpose processor 12-3-0, for example, can function as a controller that controls other constituent portions within the image forming processing unit 12-3 such as a processing unit, a bus, and an I/O controller. Following is a description of other apparatuses within that image forming processing unit 12-3.

Each of a processing unit 1 (12-3-1), a processing unit 2 (12-3-2), a processing unit 3 (12-3-3), and a processing unit 4 (12-3-4) are processors that can be controlled from the general-purpose processor 12-3-0. Below, these processing units are collectively abbreviated as “processing units 1 to 4”. Under control by the general-purpose processor, the processing units 1-4 are capable of performing processing of PDL data 100, rendering processing of generating intermediate data 101 described below, and image processing of the generated raster image data 102-1. The processing units 1 to 4 may also be respectively referred to as processors.

Furthermore, the processing units 1-4 respectively have a local memory 1 (12-3-1-1), a local memory 2 (12-3-2-1), a local memory 3 (12-3-3-1), and a local memory 4 (12-3-4-1)(below, collectively referred to as “local memories 1-4”). These local memories 1 to 4 are at least capable of saving a group of commands that determine what processing can be performed by the respective processing units 1 to 4. For example, a plurality of command groups are stored in each local memory. The general-purpose processor 12-3-0 is capable of controlling the respective processing units 1 to 4 to select a command group saved in the local memories 1 to 4. Thus, the general-purpose processor 12-3-0 is capable of determining the processing that can be performed by the respective processing units 1 to 4. For example, one command group is an optimal program code string for opening text, and another command group is an optimal program code string for opening graphic data. By separating programs into these processing types, redundant processing in the case of using a general-purpose program (for example, such as determination of object type) becomes unnecessary, so code can be optimized (made more efficient). When it is thus possible to selectively load a plurality of program code strings that differ, data can be processed by executing a program code string whereby the most efficient processing is possible for each data type.

A memory controller 12-3-5 is an interface with a main memory 12-3-6 and a ROM 12-3-9. More specifically, the memory controller 12-3-5 allows reading and writing of data to the main memory 12-3-6. Also, the memory controller 12-3-5 allows reading of data to the ROM 12-3-9.

An IO controller 12-3-8 is an interface with constituent portions outside of the image forming processing unit 12-3. More specifically, the IO controller 12-3-8 allows exchange of data with an apparatus outside of the image forming processing unit 12-3.

A local bus 12-3-7 connects the general-purpose processor 12-3-0, the respective processing units 1 to 4, the memory controller 12-3-5, and the IO controller 12-3-8. That is, the local bus 12-3-7 allows data to be exchanged between these connected apparatuses.

In the configuration described above, the image forming processing apparatus 12-3 generates print data based on PDL data. Next is a description of the configuration of the intermediate data 101 with reference to FIG. 8, and a description of the processing steps (S14 in FIG. 3) for generating print data with reference to FIG. 7.

### Intermediate Data

The intermediate data 101 is illustrated in FIG. 8. The intermediate data 101 is divided into a plurality of units of divided intermediate data 101-1. The intermediate data 101 also includes print control intermediate data 101-2. The divided intermediate data 101-1 further includes graphic data 101-1-1, text data 101-1-2, and area information 101-1-3.

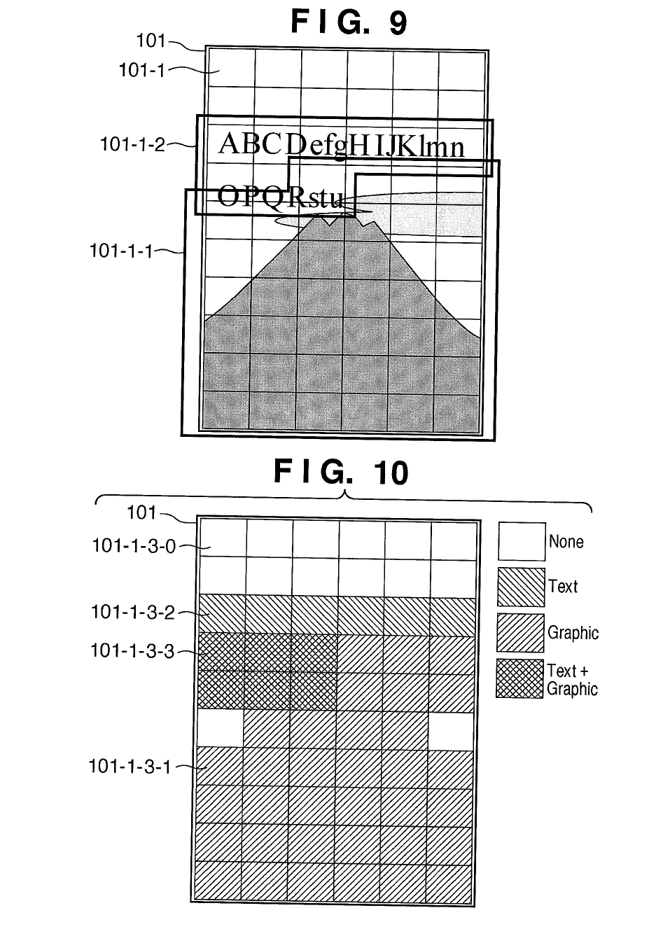

Here, the intermediate data 101 has a structure as shown in FIG. 9, for example. The divided intermediate data 101-1 includes data of respective blocks in which the intermediate data 101 is divided in space. Of course, the manner of dividing the intermediate data 101 is not limited to the division scheme shown in the example in FIG. 9; another configuration can be adopted in the present invention. However, it is desirable that the respective blocks are the same size, in order to predict the load for load distribution, or the like.

Furthermore, the respective units of divided intermediate data 101-1 can include graphic data 101-1-1 and text data 101-1-2. In this embodiment, graphic data refers to data that includes a raster image and a vector image. Also, in this embodiment, text data refers to character data to be rendered. For example, text data includes character codes, and modification information such as size and typeface.

The area information 101-1-3 includes area information of the respective units of divided intermediate data 101-1. FIG. 10 shows an example of the area information included in the intermediate data 101 in FIG. 9. In the present embodiment, the area information 101-1-3 can include four types of information. More specifically, the area information 101-1-3-0 indicates that there is no data to be rendered in that area. Area information 101-1-3-1 indicates that graphic data is to be rendered in that area. Area information 101-1-3-2 indicates that text is to be rendered in that area. Area information 101-1-3-3 indicates that text and graphics are to be rendered in that area.

The print control intermediate data 101-2 is data generated based on print control data 100-2. This print control data 100-2 at least includes information that indicates the size of a medium on which image forming is to be performed (for example, referred to as paper size), a method for binding processing, and so forth.

Above, the intermediate data 101 generated by the general-purpose processor 12-3-0 was described. Next is a description of processing to generate print data, with reference to FIG. 7.

### Print Data Generation Processing

In FIG. 7, the general-purpose processor 12-3-0 of the image forming processing unit 12-3 performs interpretation processing of the PDL data 100 to generate the intermediate data 101 (S14-0). There are a plurality of types of this PDL data 100. For example, PDF and PostScript (registered trademarks) of Adobe Systems Inc., LIPS of Canon Inc., and the like are known. From the PDL data 100, in which these different data formats exist, the general-purpose processor 12-3-0 generates the intermediate data 101, which is in a shared data format. However, it is not necessary for the general-purpose processor 12-3-0 to be compatible with all of the differing data formats; compatibility with at least any one data format is sufficient. In this example, the intermediate data is processing target data that has been converted to blocks, that is, target data. However, PDL data can also be referred to as processing target data.

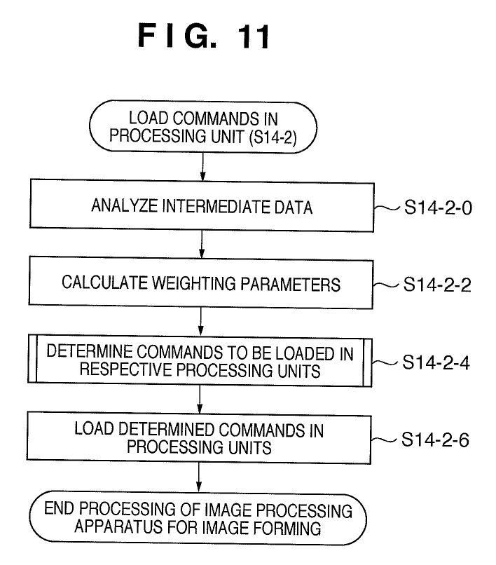

Next, the general-purpose processor 12-3-0 loads commands (a program module) in the processing unit (S14-2). The processing of S14-2 will be described with reference to FIG. 11. The general-purpose processor 12-3-0 analyzes the generated intermediate data. Based at least on that analysis, the general-purpose processor 12-3-0 determines command groups to be transferred to the respective local memories 1 to 4 of the processing units 1 to 4. More specifically, the analysis and command loading (S14-2) by the general-purpose processor 12-3-0 is performed as described below.

First, in S14-2-0, the general-purpose processor 12-3-0 at least analyzes the information indicated by the area information 101-1-3 included in the intermediate data. More specifically, from the area information 101-1-3 corresponding to the respective units of divided intermediate data 101-1 included in the intermediate data 101, the general-purpose processor 12-3-0 counts how many units of intermediate data 101-1 (i.e., blocks or tiles) exist that have been classified into respective attributes “None” 101-1-3-0, “Text” 101-1-3-2, “Graphic” 101-1-3-1, and “Text+Graphic” 101-1-3-3. Below, the number of units of divided intermediate data 101-1 indicating these attributes is referred to as the number of tiles of those attributes.

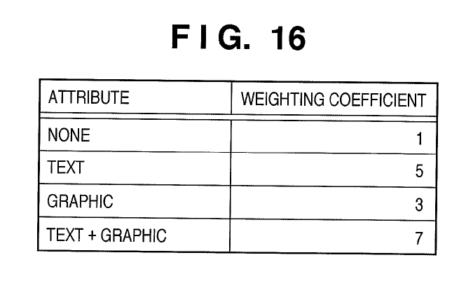

Next, in S14-2-2, the general-purpose processor 12-3-0 calculates a weighting parameter corresponding to each attribute, based on at least the information obtained in S14-2-0. More specifically, the respective weighting parameters are obtained at least by multiplying the number of tiles of each attribute by a processing burden parameter of each attribute that has been prepared in advance. The processing burden parameter of each attribute that has been prepared in advance indicates the ratio of a necessary processing burden for processing the divided intermediate data 101-1, for each attribute, in order to obtain the print data 102. In the present embodiment, for example, values such as those in FIG. 16 are given. Specifically, those values indicate that for the divided intermediate data 101-1 having the attribute of “Text” 101-1-3-2, relative to the divided intermediate data 101-1 having the attribute of “Graphic” 101-1-3-1, a processing time of 5/3 (about 1.7 times as long) is required. In FIG. 16, the values shown are relative to a reference of no data (NONE). In the present embodiment, the processing burden parameter of each attribute that has been prepared in advance is stored in the ROM 12-3-9. The general-purpose processor 12-3-0 is capable of obtaining the processing burden parameter of each attribute that has been saved in the ROM 12-3-9 via the memory controller 12-3-5.

In the present embodiment, calculation of a weighting parameter wc corresponding to an attribute is performed according to the below formula, based on at least the intermediate data obtained in S14-2-0.

wc(none)=Tile(none)×PL(none)

wc(image)=Tile (image)×PL(image)

wc(text)=Tile(text)×PL(text)

wc(image+text)=Tile(image+text)×PL(image+text) (Formula 1)

Here, wc (attr) indicates the weighting parameter of each attribute (attr), Tile (attr) indicates the number of tiles (number of blocks) of each attribute (attr), and PL (attr) indicates the processing burden parameter of each attribute (attr). The number of tiles is used as an indicator value of the amount of data. The number of tiles can be stated in terms of a number of processing units; for example, in the case of banding, the number of tiles in a band can be counted. Otherwise, the number of tiles may be counted in terms of page units, or may be counted in terms of job units. The processing burden parameters can, for example, be determined by performing measurements in advance in testing, or the like.

The calculation result wc (attr) indicates weighting of processing for each attribute that is required in order to process the intermediate data 101 and obtain the print data 102. That is, the calculation result is an indicator value of the processing burden of each attribute when processing of a particular print unit (such as a job, page, or band) is performed. A case in which, for example, the wc (attr) of a particular attribute is larger than the wc (attr) of another attribute has the following meaning. That is, the total time of processing of the divided intermediate data 101-1 that indicates the former attribute wc (attr), for obtaining the print data 102 from the intermediate data 101, is greater than the total time of processing of the intermediate data 101-1 that indicates the latter attribute.

Next, from this calculation result the general-purpose processor 12-3-0 determines commands to be loaded to the respective processing units 1 to 4 in S14-2-4.

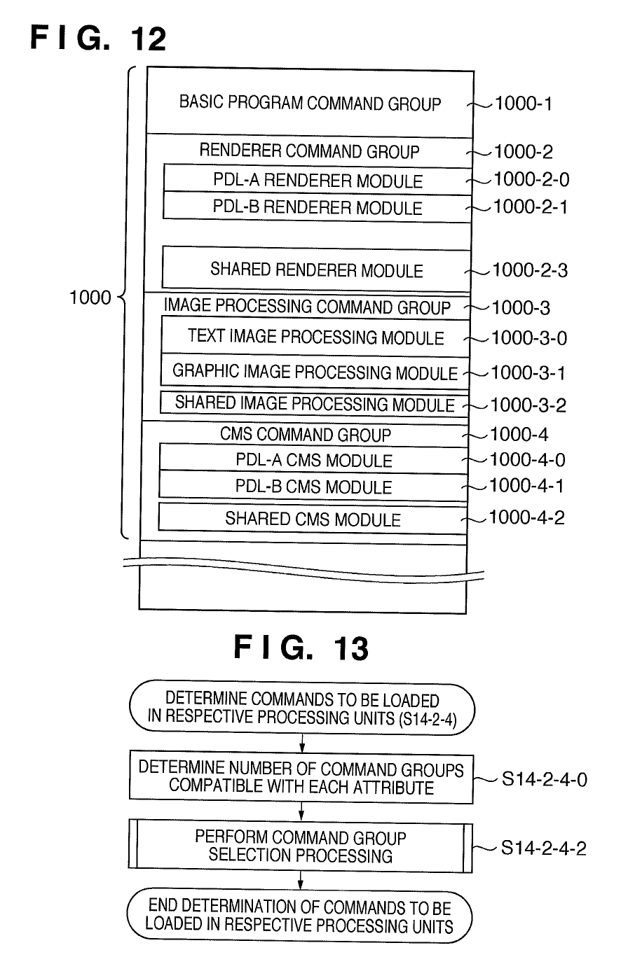

In S14-2-4, the general-purpose processor 12-3-0 selects commands saved in the ROM 12-3-9 or the main memory 12-3-6, based on the value of the wc (attr) obtained with Formula 1. FIG. 12 graphically illustrates commands saved in the ROM 12-3-9 or the main memory 12-3-6.

A command group 1000 is a command group that can be loaded to the processing units 1 to 4 in S14-4. Below is a description of the types of commands included in that command group.

### Providable Command Modules

A basic program command group 1000-1 mainly performs memory management of the local memories 1 to 4 and management of other command groups described below.

A renderer command group 1000-2 is a rendering processing program. The rendering processing stated here is processing in which rendering processing of the divided intermediate data 101-1 in the intermediate data 101, i.e. tiles, is performed to generate raster image data. The renderer command group 1000-2 further includes a PDL-A renderer module 1000-2-0, a PDL-B renderer module 1000-2-1, and a shared renderer module 1000-2-3. The respective renderer modules are program modules suitable for interpreting and rendering intermediate data that has been generated based on PDLs that differ from each other.

An image processing command group 1000-3 is a program for performing image processing of raster image data obtained in rendering processing. The image processing command group 1000-3 includes a text image processing module 1000-3-0, a graphic image processing module 1000-3-1, and a shared image processing module 1000-3-2.

A CMS (Color Management System) command group 1000-4 is a program for performing color adjustment. The CMS command group 1000-4 further includes a PDL-A CMS module 1000-4-0, a PDL-B CMS module 1000-4-1, and a shared CMS module 1000-4-2.

Next, the reason that a plurality of command groups, that is, programs, are prepared, such as command groups for PDL-A and PDL-B and for text image processing and graphic processing, is described. As described above, the PDL data 100 exists in a plurality of types of data formats. Also, as described above, for example, PDF and PostScript (registered trademarks) of Adobe Systems Inc., as well as LIPS or the like, exist as PDLs. The general-purpose processor 12-3-0 converts the plurality of types of PDL data 100 to the intermediate data 101 in a single data format. However, although the data format of the intermediate data 101 is made uniform, the data included in the intermediate data 101 can have different tendencies depending on the type of PDL data 100.

For example, with Adobe PDF, transparency information can be included in that PDL data 100. Therefore, the intermediate data 101 generated from the PDL data 100 described in PDF format includes transparency information, or information dependent on transparency information. On the other hand, with PostScript (registered trademark) or LIPS, transparency information cannot be included in the PDL data 100. Therefore, the intermediate data 101 generated from PDL data in PostScript (registered trademark) or LIPS format cannot include transparency information, or information dependent on transparency information.

Thus, because the information that can be described in the intermediate data 101 differs due to a difference in the type of PDL data 100, the processing that is necessary when generating raster image data from the intermediate data 101 also differs. That is, in the case of intermediate data 101 generated from PDL data described in Adobe PDF format, for example, it is necessary to generate raster image data by processing transparency information or information that depends on transparency information. However, in the case of intermediate data 101 generated from PDL data described in PostScript (registered trademark) or LIPS format, for example, it is not necessary to generate raster image data by processing transparency information or information that depends on transparency information.

In the present embodiment, in consideration of the difference in necessary processing, a plurality of types of commands (program modules) are recorded to the ROM 12-3-9 or the main memory 12-3-6. For example, the PDL-A renderer module is for PostScript (registered trademark), and has a function for processing transparency information and a function of outputting raster data in a CMYK color system. On the other hand, the PDL-B renderer module is for another PDL, and does not have a function for processing transparency information, but has a function of outputting raster data in an RGB color system. Of course, these are only examples.

Next is a description of the text image processing module 1000-3-0 and the graphic image processing module 1000-3-1 included in the image processing command group 1000-3. The text image processing module 1000-3-0 is capable of performing image processing specific to text, such as edge emphasis of text portions. On the other hand, the graphic image processing module 1000-3-1 does not have a text-specific processing function such as edge emphasis, but rather, has a processing function such as processing to perform red-eye correction or skin-color correction in a photograph.

As described above, the divided intermediate data 101-1 included in the intermediate data 101 can have the attribute information 101-1-3. This attribute information 101-1-3 indicates properties of the rendering data included in the divided intermediate data 101-1. However, from the attribute information 101-1-3, the general-purpose processor 12-3-0 or the processing units 1 to 4 can determine whether a particular divided intermediate data 101-1 requires the processing of the text image processing module 1000-3-0 or requires the processing of the graphic image processing module 1000-3-1.

In the present embodiment, in consideration of the difference in necessary processing for each attribute, a plurality of types of commands are recorded to the ROM 12-3-9 or the main memory 12-3-6.

Next, the PDL-A CMS module and the PDL-B CMS module 1000-4-1 included in the CMS command group 1000-4 will be described. As stated above, there are a plurality of types of the PDL data 100. Therefore, necessary processing for color adjustment also differs, depending on the type of PDL data 100. According to the language specification of PostScript (registered trademark), for example, it is necessary to perform rendering processing in a CMYK color space. Therefore, in the present embodiment, the general-purpose processor 12-3-0 and the processing units 1 to 4 perform processing of the PDL data 100 and the intermediate data 101 in the CMYK color space when the PDL data that has been input to the image forming processing apparatus 12-3 is in PostScript (registered trademark) format.

On the other hand, in the case of PDL data 100 in LIPS format or the like, color adjustment may be performed in an RGB color space rather than in a CMYK color space. Incidentally, the amount of information necessary to express colors is less in the RGB color space than in the CMYK color space. Therefore, when color adjustment is performed in the RGB color space, it is possible to increase the speed of processing and reduce the amount of memory necessary, compared to performing color adjustment processing in the CMYK color space. Therefore, it is desirable that the general-purpose processor 12-3-0 and the processing units 1 to 4 perform processing of the intermediate data 101 generated from PDL data 100 in LIPS format or the like, which can be processed in the RGB color space, in the RGB color space. The reason for this is that improved processing speed and a reduction in the amount of memory necessary for processing can be expected.

In the present embodiment, in consideration of the difference in necessary processing, a plurality of types of commands, that is, a plurality of types of program modules, are recorded to the ROM 12-3-9 or the main memory 12-3-6. For example, the PDL-A CMS module is for PostScript (registered trademark), and performs processing of a CMYK color system. This module may also have a function of performing processing related to transparency information. Also, for example, the PDL-B CMS module is for another PDL, and performs processing of an RGB color system. This module does not require a function of performing processing related to transparency information.

Above, command groups (program modules) to be determined in S14-2-4 by the general-purpose processor 12-3-0 from the results of calculating weighting parameters were described.

### Program Module Selection Processing

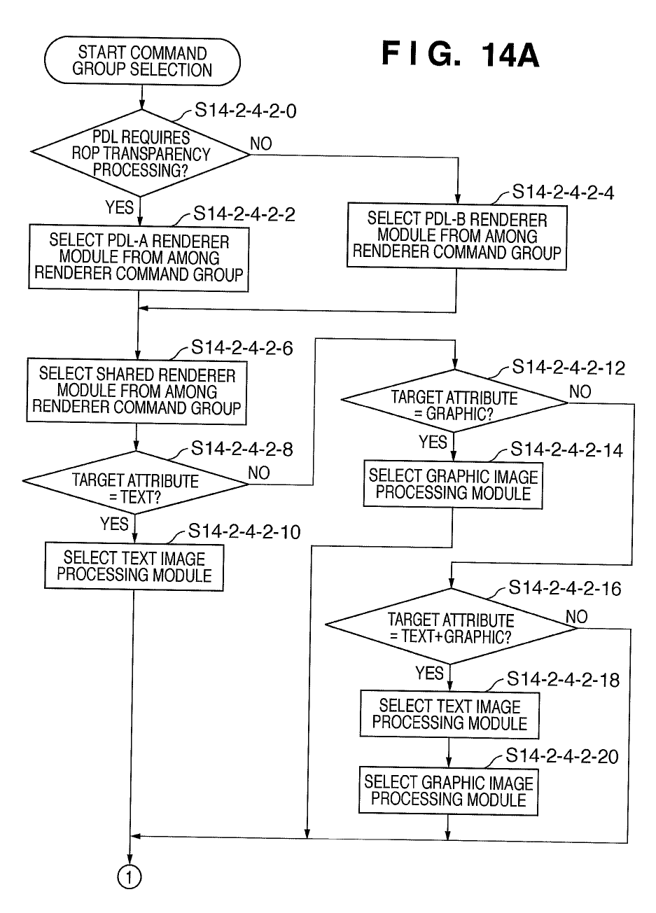

Next is a description of processing in S14-2-4 in which the general-purpose processor 12-3-0 selects commands to be loaded in the processing units 1 to 4. The processing in S14-2-4 is graphically illustrated in more detail in FIG. 13.

First, in S14-2-4-0, the general-purpose processor 12-3-0 determines the number of program modules that correspond to each attribute. This processing determines the number of types of program modules to be loaded in the plurality of processing units (12-3-1, 12-3-2, 12-3-3, and 12-3-4).

In the present embodiment, the command groups (program modules) loaded in the processing units 1 to 4 are at least associated with the attribute information 101-1-3. That is, the general-purpose processor 12-3-0 is at least capable of selecting the following as commands (program modules) to be loaded in at least the processing units 1 to 4.
1. A program module associated with divided intermediate data 101-1 in which the attribute information 101-1-3 indicates “Text” 101-1-3-2
2. A program module associated with divided intermediate data 101-1 in which the attribute information 101-1-3 indicates “Graphic” 101-1-3-1
3. A program module associated with divided intermediate data 101-1 in which the attribute information 101-1-3 indicates “Text+Graphic” 101-1-3-3

From at least the weighting parameters given by Formula 1, the general-purpose processor 12-3-0 determines how many of these respective commands (program modules) should be loaded in the processing units 1 to 4.

For example, it is assumed that the following calculation results are obtained:

wc(text)=30.0

wc(graphic)=42.0

wc(text+graphic)=102.0

Here, in the present embodiment, there are four processing units, as shown in FIG. 6. Therefore, the general-purpose processor 12-3-0 normalizes the weighting coefficient we (attr) such that the total of values indicating the respective ratios is 4. That is, the weighting coefficient is normalized such that the total value is the same as the number of processing units to which processing such as rendering is distributed. The general-purpose processor 12-3-0 of the image forming processing unit 12-3 performs this normalization to convert the above weighting coefficient to generally values as indicated below. Here, “normal” indicates a value that has been normalized.

normal(wc(text))=0.69

normal(wc(graphic))=0.97

normal(wc(text+graphic))=2.35

These weighting coefficient values indicate the ratio of the load of processing associated with the attribute information. Therefore, based on the obtained weighting coefficient values, the general-purpose processor 12-3-0 can determine how many of the respective command groups (program modules) associated with attribute information should be loaded in the processing units 1 to 4. Because division into less than one processing unit is not possible, the general-purpose processor 12-3-0 performs processing in the following manner.
1. When a processing coefficient is less than 1, the processing coefficient is rounded up to 1. That is, one processing unit is allocated for processing of tiles of intermediate data of the corresponding attribute.
2. The number of allocated processing units is subtracted from the total value (that is, the total number of processing units) of the weighting coefficient.
3. The value obtained by subtraction is divided by the ratio of the weighting coefficient values corresponding to the remaining attribute. Division is of course performed so as to result in an integer.
4. In the above procedure, if the total value of the number of processing units is excessive or inadequate, for example with respect to an attribute to which the most processing units have been allocated, adjustment may be performed with that number of processing units, for example. Thus, it is generally possible to determine the number of processing units allocated to each attribute from the weighting coefficient ratio of each attribute. In this case, not only the number of processing units, but also the processing unit allocated to each attribute, may be determined.

In the present embodiment, by way of specific example, the following is true.
1. The general-purpose processor 12-3-0 determines to load, in the processing units 1 to 4, one command associated with divided intermediate data 101-1 in which the attribute information 101-1-3 indicates “Text” 101-1-3-2. This is because the weighting coefficient is less than 1.
2. The general-purpose processor 12-3-0 determines to load, in the processing units 1 to 4, one command associated with divided intermediate data 101-1 in which the attribute information 101-1-3 indicates “Graphic” 101-1-3-1. This is because the weighting coefficient is less than 1.
3. The general-purpose processor 12-3-0 determines to load, in the processing units 1 to 4, two commands associated with divided intermediate data 101-1 in which the attribute information 101-1-3 indicates “Text+Graphic” 101-1-3-3. This is because all of the remaining processing units are allocated.

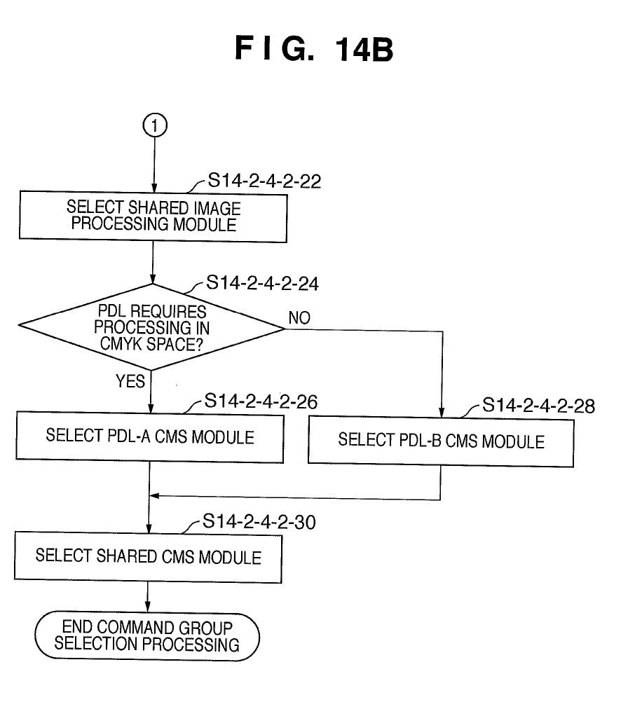

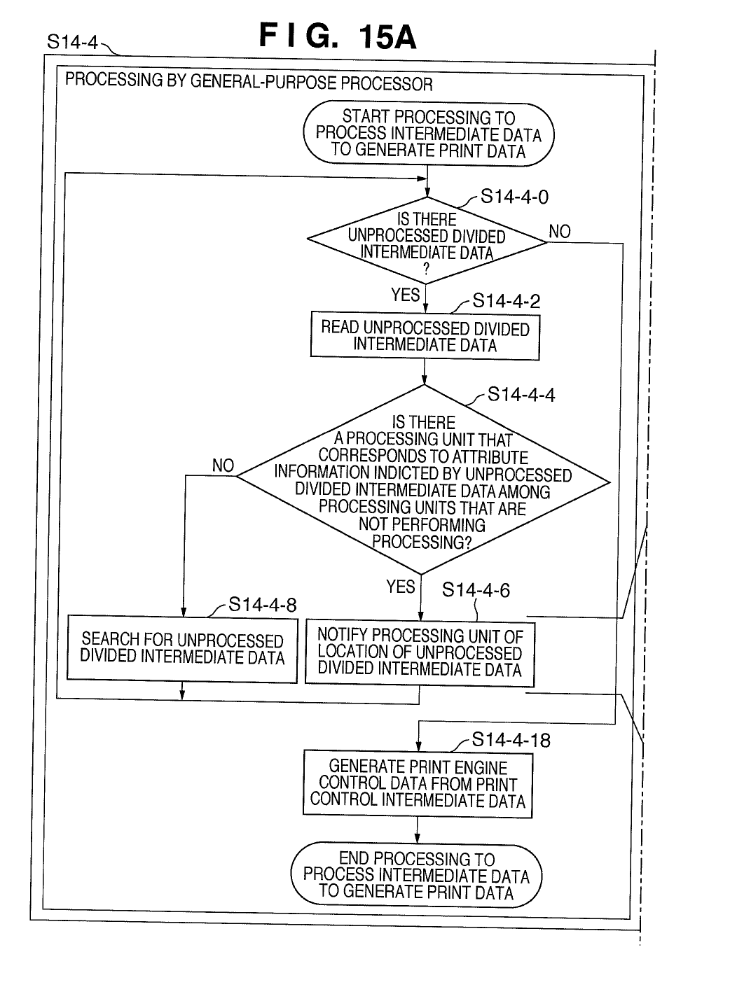

Above, the general-purpose processor 12-3-0 determined how many of the respective command groups associated with the attribute information 101-1-3 should be loaded in the processing units 1 to 4. Next, in S14-2-4-2, the general-purpose processor 12-3-0 performs processing to select commands in order to generate the respective command groups described above. In this command selection processing, first, attributes are associated with the respective processing units by the general-purpose processor 12-3-0. Then, the processing in FIGS. 14A and 14B is performed for each attribute indicated by the area information (attribute information) 101-1-3. As a result of the processing in FIGS. 14A and 14B, a program module corresponding to an attribute is selected. The selected program module is loaded into the local memory of the processing unit that has been allocated to that attribute. When a plurality of processing units have been allocated to one attribute, a program module shared by all of those processing units is loaded.

FIGS. 14A and 14B illustrate the command selection processing in S14-2-4-2 in more detail. Below, the command selection processing in S14-2-4-2 is described in more detail with reference to FIGS. 14A and 14B.

First, in S14-2-4-2-0, the general-purpose processor 12-3-0 determines whether the PDL data 100 used for generation of the intermediate data 101 is a type capable of describing processing such as ROP or transparency processing. When the intermediate data 101 has been generated from PDL data 100 of a type capable of describing processing such as ROP or transparency processing, the general-purpose processor 12-3-0 proceeds to S14-2-4-2-2. When the intermediate data 101 has not been generated from PDL data 100 of a type capable of describing processing such as ROP or transparency processing, the general-purpose processor 12-3-0 proceeds to S14-2-4-2-4.

In S14-2-4-2-2, the general-purpose processor 12-3-0 selects the above-described PDL-A renderer module 1000-2-0 as the command to be loaded in the processing units 1 to 4. On the other hand, in S14-2-4-2-4, the general-purpose processor 12-3-0 selects the above-described PDL-B renderer module 1000-2-1 as the command to be loaded in the processing units 1 to 4.

Next, in S14-2-4-2-6, the general-purpose processor 12-3-0 selects the above-described shared renderer module 1000-2-3 as the command to be loaded in the processing units 1 to 4.

With the above processing, selection of commands in the renderer command group 1000-2 by the general-purpose processor 12-3-0 is completed.

Next, in S14-2-4-2-8, the general-purpose processor 12-3-0 checks whether or not the attribute indicated by the attribute information 100-1-3, which is the target of processing, is “Text”. If the attribute is “Text”, the general purpose processor 12-3-0 proceeds to S14-2-4-2-10. On the other hand, if the attribute is not “Text”, the general purpose processor 12-3-0 proceeds to S14-2-4-2-12. In S14-2-4-2-10, the general purpose processor 12-3-0 selects the above-described text image processing module 1000-3-0 as the commands to be loaded in the processing units 1 to 4.

In S14-2-4-2-12, the general-purpose processor 12-3-0 checks whether or not the attribute indicated by the attribute information 100-1-3, which is the target of processing, is “Graphic”. If the attribute is “Graphic”, the general purpose processor 12-3-0 proceeds to S14-2-4-2-14. On the other hand, if the attribute is not “Graphic”, the general purpose processor 12-3-0 proceeds to S14-2-4-2-16. In S14-2-4-2-14, the general purpose processor 12-3-0 selects the above-described graphic image processing module 1000-3-1 as the commands to be loaded in the processing units 1 to 4.

In S14-2-4-2-16, the general-purpose processor 12-3-0 checks whether or not the attribute indicated by the attribute information 100-1-3, which is the target of processing, is “Text+Graphic”. If the attribute is “Text+Graphic”, the general purpose processor 12-3-0 proceeds to S14-2-4-2-18. On the other hand, if the attribute is not “Text+Graphic”, the general purpose processor 12-3-0 proceeds to S14-2-4-2-22. In S14-2-4-2-18, the general purpose processor 12-3-0 selects the above-described text image processing module 1000-3-0 as the commands to be loaded in the processing units 1 to 4. In S14-2-4-2-20, the general purpose processor 12-3-0 selects the above-described graphic image processing module 1000-3-1 as the commands to be loaded in the processing units 1 to 4.

After performing the above processing, in S14-2-4-2-22, the general purpose processor 12-3-0 selects the above-described shared image processing module 1000-3-2 as the commands to be loaded in the processing units 1 to 4.

With the above processing, selection of commands in the image processing command group 1000-3 by the general-purpose processor 12-3-0 is completed.

Next, in S14-2-4-2-24, the general-purpose processor 12-3-0 checks whether the PDL data 100 used for generation of the intermediate data 101 is PDL data 100 of a type that requires processing in the CMYK color space. If the PDL data 100 is of a type that requires processing in the CMYK color space, the general-purpose processor 12-3-0 proceeds to S14-2-4-2-26. On the other hand, if the PDL data 100 is of a type that does not require processing in the CMYK color space, the general-purpose processor 12-3-0 proceeds to S14-2-4-2-28. In S14-2-4-2-26, the general purpose processor 12-3-0 selects the above-described PDL-A CMS module 1000-4-0 as the commands to be loaded in the processing units 1 to 4. In S14-2-4-2-28, the general purpose processor 12-3-0 selects the above-described PDL-B CMS module 1000-4-1 as the commands to be loaded in the processing units 1 to 4.

After performing the above processing, in S14-2-4-2-30, the general purpose processor 12-3-0 selects the above-described shared CMS module 1000-4-2 as the commands to be loaded in the processing units 1 to 4.

Above, the processing in S14-2-4-2 to select these commands is performed by the general-purpose processor 12-3-0 the same number of times as the number of attributes indicated by the attribute information 101-1-3. By performing this repeated processing, the general-purpose processor 12-3-0 generates command groups associated with the attributes indicated by the attribute information 101-1-3.

Of course, a configuration may also be adopted in which, without performing this sort of processing, a table in which PDL types and attributes are associated with program module identifiers is prepared in a ROM or the like, and a program module associated with a PDL type and attribute is selected. Association in such a case is performed essentially as shown in FIGS. 14A and 14B. Selection of a program module can be performed more quickly by employing such a table.

### Program Module Loading

Above a detailed description of S14-2-4 was given, and below a detailed description of S14-2-6 shown in FIG. 11 will be given. In S14-2-8, the general-purpose processor 12-3-0 loads the command group selected in S14-2-6 in the respective processing units 1 to 4. With this loading processing S14-2-8, a command group (program) is loaded in the local memories 1 to 4 in the respective processing units 1 to 4. By a command group being loaded in the local memories 1 to 4, the processing of S14-4, in which the processing units 1 to 4 process the intermediate data 101 to generate the print data 102, is made possible.

Above, a description was given of the processing in S14-2 shown in FIG. 11 in which commands are loaded to the processing units 1 to 4.

### Print Data Generation Processing

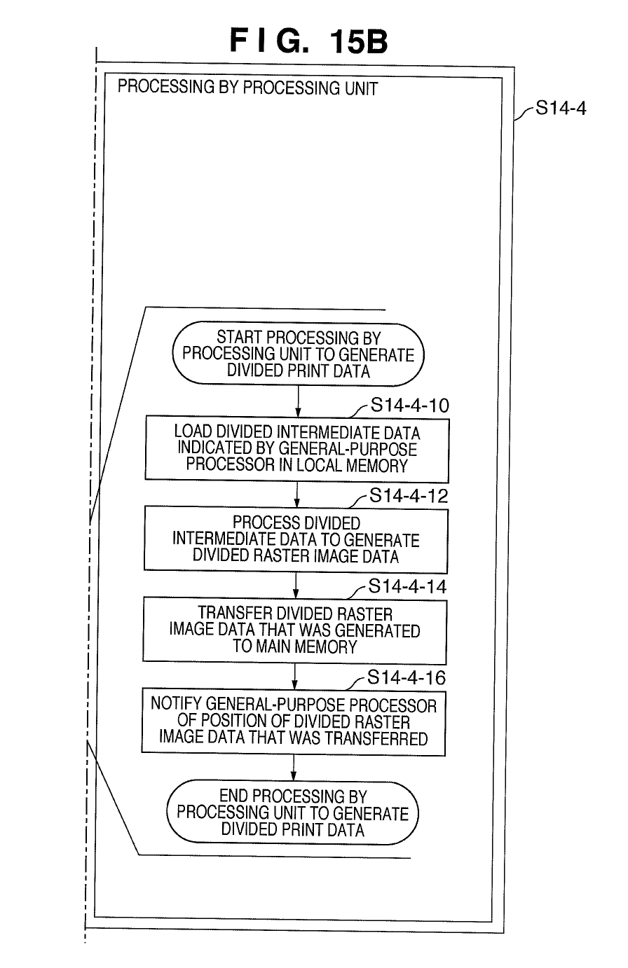

Next is a description of processing in S14-4, in which the intermediate data 101 is processed to generate the print data 102, with reference to FIGS. 15A and 15B.

First, in S14-4-0, the general-purpose processor 12-3-0 checks whether there is unprocessed divided intermediate data 101-1. Here, unprocessed divided intermediate data means a portion of the intermediate data 101 for which processing to generate the print data 102 has not yet finished.

If there is unprocessed intermediate data 101-1, the general-purpose processor 12-3-0 proceeds to S14-4-2. On the other hand, if there is no unprocessed intermediate data 101-1, the general-purpose processor 12-3-0 ends the processing of S14-4.

Next, in S14-4-2, the general-purpose processor 12-3-0 reads the next unprocessed intermediate data 101-1. With this processing, the general-purpose processor 12-3-0 can check which attributes are indicated by the attribute information 101-1-3 in the unprocessed divided intermediate data 101-1.

Next, in S14-4-4, the general-purpose processor 12-3-0 checks whether there is a processing unit 1 to 4 that corresponds to the attribute information 101-1-3 indicated by the unprocessed divided intermediate data 101-1 among the processing units 1 to 4 that are not performing processing. If there is a processing unit 1 to 4 that corresponds to the attribute information 101-1-3 indicated by the unprocessed divided intermediate data 101-1, which is the processing target, among the processing units 1 to 4 that are not performing processing, the general-purpose processor 12-3-0 proceeds to S14-4-6. When the result of this determination is that none of the processing units 1 to 4 is not performing processing, or that there is no processing unit 1 to 4 that corresponds to the attribute information 101-1-3 indicated by the unprocessed divided intermediate data 101-1 among the processing units 1 to 4 that are not performing processing, the general-purpose processor 12-3-0 proceeds to S14-4-8.

Next, in S14-4-8, the general-purpose processor 12-3-0 performs processing to search for a next piece of unprocessed divided intermediate data 101-1. With this processing, if a next piece of unprocessed divided intermediate data 101-1 is found in S14-4-8, then in the next instance of the processing indicated in S14-4-2, the general-purpose processor 12-3-0 performs processing with focus on the unprocessed divided intermediate data 101-1 that was found in S14-4-8.

In S14-4-8, when all of the processing units are busy, it is desirable to wait until processing in any of the processing units finishes.

This is because when all of the processing units are busy, even if a piece of unprocessed divided intermediate data is newly found, that divided intermediate data cannot be processed. In such a case, after the processing in any processing unit finishes, the processing from S14-4-8 onward is resumed.

On the other hand, in S14-4-6, the general-purpose processor 12-3-0 notifies the processing units 1 to 4 found in S14-4-4 of the above unprocessed divided intermediate data 101-1. That is, notification of the processing target data is given in block units. The content of the notification includes information for specifying a processing target, for example the address and size of the processing target. The content of the notification may also be the intermediate data itself. Thus, the target processing units 1 to 4 generate the divided raster image data 102-1-1 based on the divided intermediate data 101-1.

Next is a description of processing performed by the processing units 1 to 4 that receive the notification in above S14-4-6.

First, in S14-4-10, the processing units 1 to 4 read the unprocessed divided intermediate data 101-1 indicated by the general-purpose processor 12-3-0. In the present embodiment, this divided intermediate data 101-1 is saved in the main memory 12-3-6. With the processing in S14-4-10, the processing units 1 to 4 can load the unprocessed divided intermediate data 101-1 in the local memories 1 to 4.

Next, in S14-4-12, the processing units 1 to 4 process the divided intermediate data to generate the divided raster image data 102-1-1. The processing units 1 to 4 execute the processing in S14-4-12 using the command groups generated by the general-purpose processor 12-3-0 in S14-2-4-2. Also, in the present embodiment, the processing units 1 to 4 save the divided raster image data 102-1-1 in the local memories 1 to 4.

Next, in S14-4-14, the processing units 1 to 4 transfer the divided raster image data 102-1-1 generated in the local memories 1 to 4 to the main memory 12-3-6.

Next, in S14-4-16, the processing units 1 to 4 notify the general-purpose processor 12-3-0 of the position in the main memory 12-3-6 of the divided raster image data 102-1-1 that was transferred.

With the above processing in S14-4-10 to S14-4-16, the processing units 1 to 4 can generate the divided raster image data 102-1-1 in the main memory from the unprocessed divided intermediate data 101-1. The divided processed raster image data is consolidated or combined in the manner before that data was divided, and stored in the main memory.

That is, the general-purpose processor 12-3-0 and the processing units 1 to 4 perform processing as described below and as shown in FIGS. 15A and 15B. As long as there exists unprocessed divided intermediate data 101-1, the below processing is repeated.
1. The general-purpose processor 12-3-0 instructs the processing units 1 to 4 to perform processing to generate the divided raster image data 102-1 (S14-4-10 to S14-4-16).
2. The processing units 1 to 4 generate the raster image data 102-1 required by the print engine 12-4 in the image forming of S18.

Next, in S14-4-18, the general-purpose processor 12-3-0 generates the print engine control data 102-2 based on the print control intermediate data 101-2.

Above, with the processing in S14, the general-purpose processor 12-3-0 and the processing units 1 to 4 generate the print data 102 used by the print engine 12-4 for image forming, based on the intermediate data 101. The processing in S14 enables the print engine to obtain the print data 102 in S16.

As described above, in the present embodiment, the image generation processing unit 12-3, which has at least two of the processing units 1 to 4, performs the processing below.
1. The image forming processing apparatus 12-3 obtains intermediate data 101, which has data that includes divided vector data.
2. The general-purpose processor 12-3-0 calculates processing burden parameters (see Formula 1) from the attribute information 101-1-3 in this intermediate data 101 and the processing burden parameters (see FIG. 16).
3. The general-purpose processor 12-3-0 determines a program module, which determines the processing that can be performed by the processing units 1 to 4, based on the above processing burden parameters and PDL type information.
4. The general-purpose processor 12-3-0 loads the determined program module in the processing units 1 to 4. Thus, the processing that can be performed by the processing units 1 to 4 is changed.
5. The processing units 1 to 4 generate the print data 102 having the raster image data 102-1 based on the above data 101-1 including divided vector data.

### Effects of the Present Embodiment

With the above processing, it is possible to avoid having a plurality of instances of switching processing or switching commands. More specifically, there are effects as follows in rendering processing and image processing of data that includes divided vector data. That is, the image forming processing apparatus 12-3 can start rendering processing and image processing after determining the processing that can be performed by the processing units 1 to 4 according to the processing burden in advance. Therefore, the configuration of the processing units 1 to 4 is not changed while this processing is being performed, and so high speed processing is possible.

In the present embodiment, attributes are classified as text, graphic, or a combination of text and graphic, but other classifications may also be used. For example, classifications of fill processing, raster image processing, and a combination thereof, and so forth can be used.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-006113, filed Jan. 14, 2009, which is hereby incorporated by reference herein in its entirety.

What is claimed is:

1. An image forming apparatus having a plurality of processors and a controller that controls the processors, the image forming apparatus comprising:
a coefficient acquisition unit configured to obtain, for target data that has been converted to blocks and is the target of image forming processing, a weighting coefficient of the processing burden of each attribute included in the target data, based on an indicator value that indicates a number of blocks of each attribute and a processing burden for each attribute;
an allocation unit configured to use a ratio of the weighting coefficients to determine a number of processors that process blocks of each attribute from among the plurality of processors, and allocate a processor to each attribute;
a loading unit configured to load a processing program corresponding to the attribute allocated to each processor in a local memory of the respective processors;
a control unit configured to perform control such that for each block of the target data, the processing program is executed and processing is performed by the allocated processor corresponding to the attribute of the corresponding block; and
a combining unit configured to combine the processed data of blocks processed by the processor.

2. The image forming apparatus according to claim 1, wherein the loading unit, in addition to attributes allocated to each processor, loads a processing program corresponding to the type of a page description language in which the target data is described.

3. The image forming apparatus according to claim 1, wherein the attributes include text, graphic, and a combination of text and graphic.

4. The image forming apparatus according to claim 1, wherein the processing program includes a renderer module that renders target data or an image processing module that performs image processing of target data, or includes a renderer module and an image processing module.

5. The image forming apparatus according to claim 1, further comprising an image forming unit configured to form an image on a print medium, based on the processed data that has been combined.

6. A method for controlling an image forming apparatus having a plurality of processors and a controller that controls the processors, the control method comprising:
a step of a weighting unit of the image forming apparatus obtaining, for target data that has been converted to blocks and is the target of image forming processing, a weighting coefficient of the processing burden of each attribute included in the target data, based on an indicator value that indicates a number of blocks of each attribute and a processing burden for each attribute;
a step of an allocation unit of the image forming apparatus using a ratio of the weighting coefficients to determine a number of processors that process blocks of each attribute from among the plurality of processors, and allocating a processor to each attribute;
a step of a loading unit of the image forming apparatus loading a processing program corresponding to the attribute allocated to each processor in a local memory of the respective processors;
a step of a control unit of the image forming apparatus performing control such that for each block of the target data, the processing program is executed and processing is performed by the allocated processor corresponding to the attribute of the corresponding block; and
a step of a combining unit of the image forming apparatus combining the processed data of blocks processed by the processor.

7. A computer-readable recording medium, on which is recorded a program for causing a computer to execute each step of the method for controlling an image forming apparatus according to claim 6.
